(19) United States
(12) Patent Application Publication
(10) Pub. No.: US 2017/0197539 A1
(43) Pub. Date: Jul. 13, 2017

(54) TRUCK BED CARGO RETENTION SYSTEM

(71) Applicant: Turnberry Innovations, LLC, Marietta, GA (US)

(72) Inventors: William Burd, Columbus, IN (US); Stephen Burd, Hilton Head, SC (US)

(73) Assignee: Turnberry Innovations, LLC, Marietta, GA (US)

(21) Appl. No.: 14/992,017

(22) Filed: Jan. 10, 2016

(51) Int. Cl. B60P 7/08

(52) U.S. Cl. CPC B60P 7/0807

(57) ABSTRACT

A cargo retention system for retaining a cargo apparatus in the bed of a truck is disclosed. The retention system has a rear bracket attachable to the bed of the truck and a front bracket attachable to the bed of the truck. The cargo apparatus has a rear male protrusion attached to and extending from a rear portion of the cargo apparatus configured to be received within the rear bracket orifice by sliding the cargo apparatus toward the rear of the bed of the truck toward the cab, and also a clasp attached to its front portion configured to selectively engage the front bracket.

### FIELD OF THE INVENTION

The present invention relates generally to a cargo retention system and, more specifically, the present invention relates to a cargo retention system for use in the bed of a pick-up truck.

### BACKGROUND OF THE INVENTION

Tool boxes and other cargo apparatus are manufactured to be installed in a variety of pick-up truck makes and models. Due to the manner in which these devices are installed in and attached to the vehicles, it is often necessary to manufacture the cargo apparatus uniquely for a specific truck make and model. Most of these cargo apparatuses span the full width of the bed of the truck and hang from the side rails of the truck. The custom nature of these products makes them expensive.

It remains desirable in the art to provide a cargo retention system for the bed of trucks that addresses the limitations associated with known systems, including but not limited to those limitations discussed above.

### SUMMARY OF THE INVENTION

In accordance with the purposes of this invention, as embodied and broadly described herein, this invention, in one aspect, relates to a In one aspect, described herein is a cargo retention system for retaining a cargo apparatus in the bed of a truck. The Figures show the cargo apparatus as a toolbox, but it is contemplated that the retention system could easily be used to retain other apparatuses, as well. For example and not meant to be limiting, the cargo apparatus can comprise a tool box, a storage box, a bicycle rack, a barbecue grill, a dog crate, and the like.

The retention system has a rear bracket attachable to the bed of the truck. The rear bracket can be positioned in the truck bed to act as a stop for the cargo apparatus as the cargo apparatus is slid toward the rear of the bed, nearer to the cab. In another exemplified aspect, the retention system also comprises a front bracket attachable to the bed of the truck. The front bracket is positioned at a point where it can be attached to a front portion of the cargo apparatus. In one aspect, the front bracket defines a front bracket orifice for engaging a portion of the front clasp.

In another aspect, the cargo apparatus comprises a rear male protrusion attached to and extending from a rear portion of the cargo apparatus. This male protrusion is configured to be received within the rear bracket orifice by sliding the cargo apparatus toward the rear of the bed of the truck toward the cab. The cargo apparatus also comprises a clasp attached to its front portion configured to selectively engage the front bracket.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of one aspect of a cargo retention system as described herein;

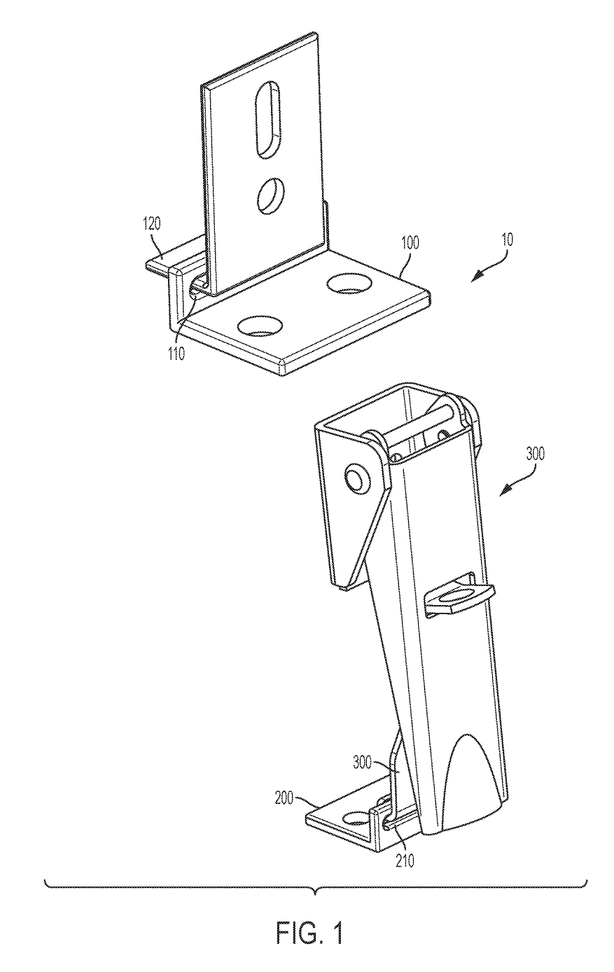

FIG. 2 is a perspective view of one aspect of a cargo retention system, showing two rear brackets and one front bracket;

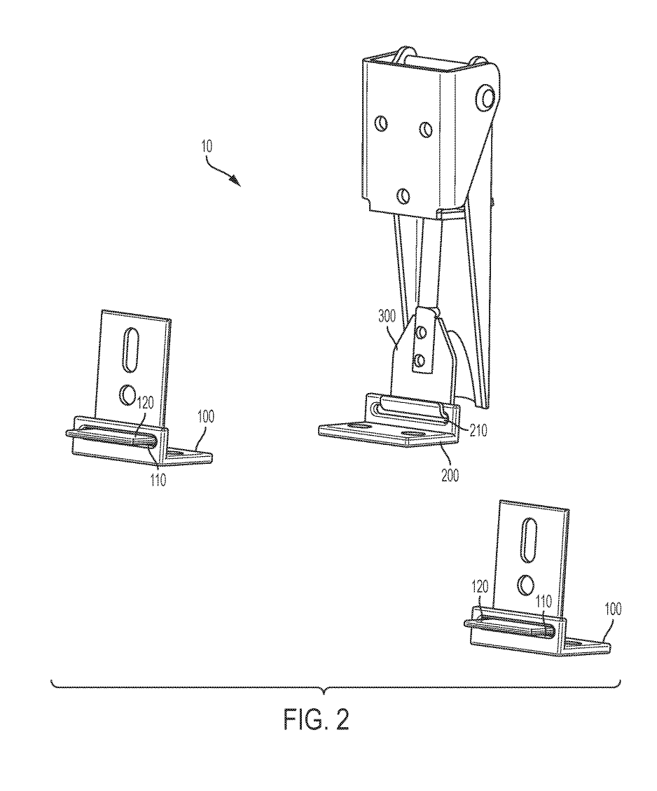

FIG. 3 is a perspective view of the front bracket and front clasp of the cargo retention system of FIG. 2;

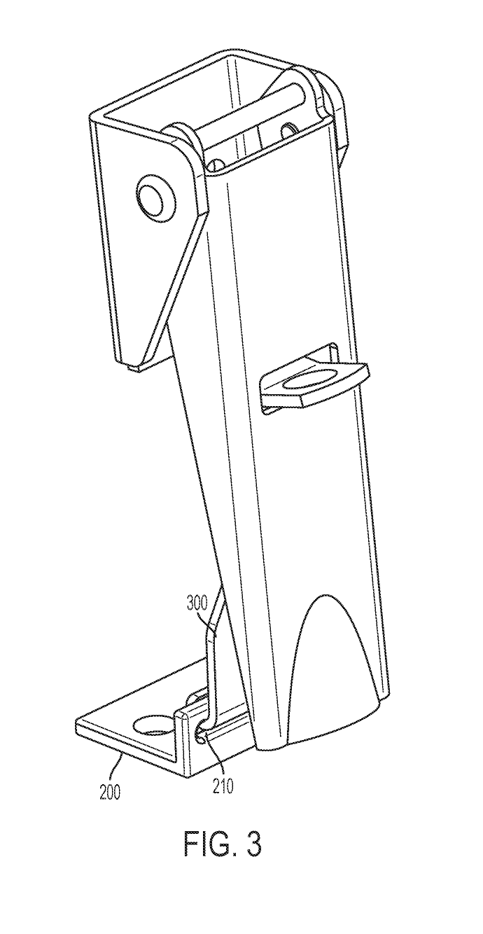

FIG. 4 is a perspective view of a rear bracket and male protrusion of the cargo system of FIG. 2;

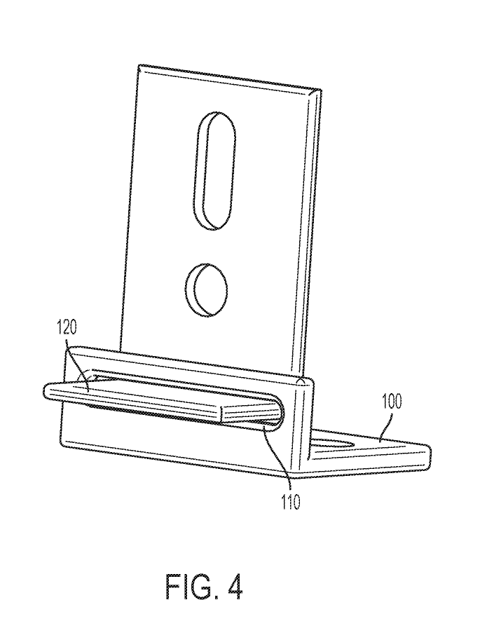

FIG. 5 is a perspective view of a pick-up truck with the cargo retention system of FIG. 2 installed therein;

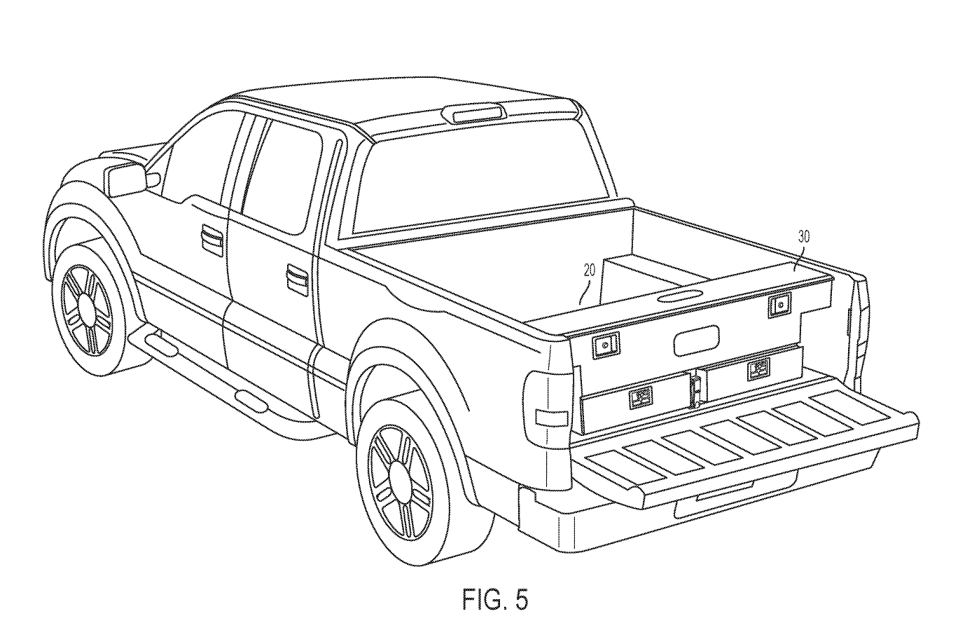

FIG. 6 is a partially exploded perspective view of the pick-up truck and cargo retention system of FIG. 5; and

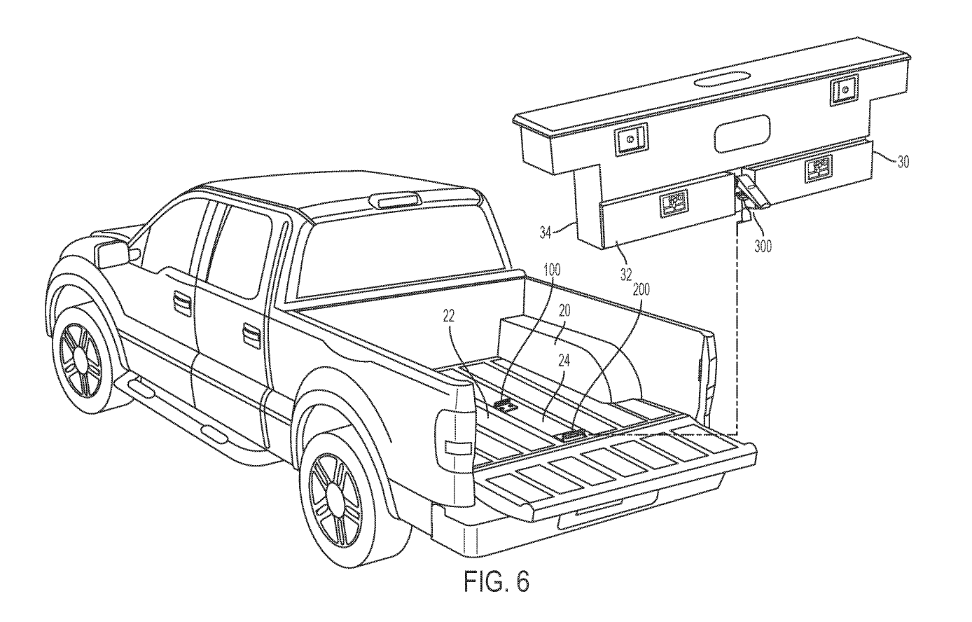

FIG. 7 is a close up perspective view of front and rear brackets installed within troughs in the bed of the pick-up truck in FIG. 5.

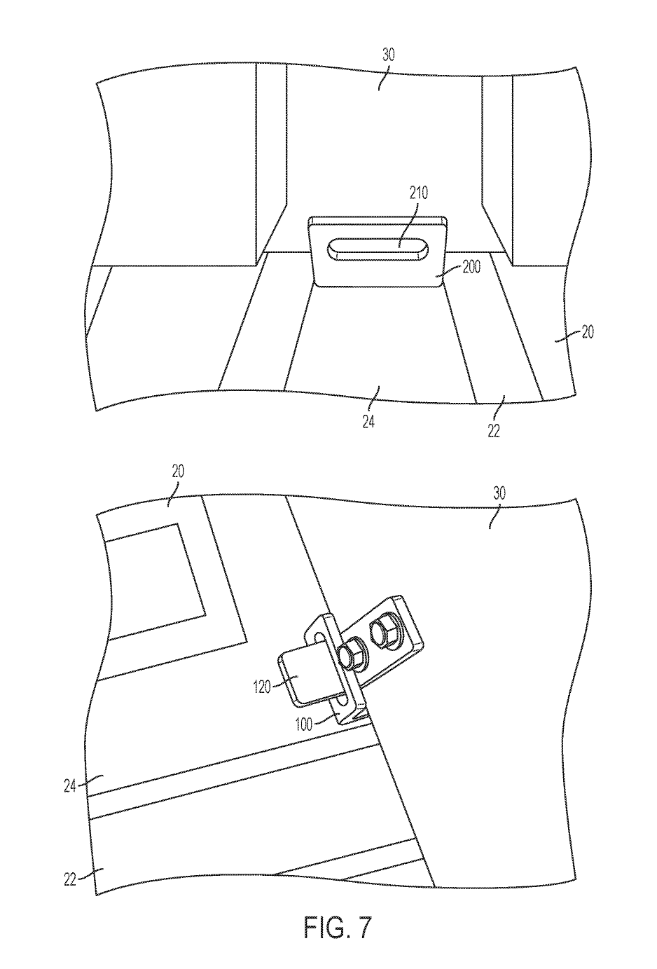

### DESCRIPTION OF THE PREFERRED EMBODIMENTS

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof

As used herein, the singular forms “a,” “an” and “the” include plural referents unless the context clearly dictates otherwise. Thus, for example, reference to a “plate” includes aspects having two or more plates unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

The term “substantially,” as used herein, may be applied to modify any quantitative representation which could permissibly vary without resulting in a change in the basic function to which it is related.

Additionally, descriptive terms, such as “first” or “second” do not necessarily connote plural referents. Alternatively, these terms are merely used to differentiate one object from another or to simply describe a single object. They are not necessarily to be considered in numerical order. For example, a “first object” could just as easily be named “object A” or the like.

Reference will now be made in detail to various embodiments of the present invention, examples of which are illustrated in the accompanying drawings. Wherever possible, the same reference numbers are used throughout the drawings to refer to the same or like parts.

In one aspect, described herein is a cargo retention system 10 for retaining a cargo apparatus 30 in the bed 20 of a truck. The Figures show the cargo apparatus 30 as a toolbox, but it is contemplated that the retention system 10 could easily be used to retain other apparatuses, as well. For example and not meant to be limiting, the cargo apparatus can comprise a tool box, a storage box, a bicycle rack, a barbecue grill, a dog crate, and the like. It is also contemplated that this system can be used in many different makes and models of trucks without a change to the design of the system.

The retention system has a first rear bracket 100 attachable to the bed 20 of the truck. The retention system can also have a second rear bracket 100 attachable to the bed 20 of the truck. The rear bracket 100 can be positioned in the truck bed to act as a stop for the cargo apparatus as the cargo apparatus is slid toward the rear of the bed, nearer to the cab. When we discuss the rear brackets, we contemplate the first rear bracket, a second rear bracket, and so on. In one aspect, the first rear bracket 100 defines a first rear bracket orifice 110 therein, should there be a second rear bracket 100, it also defines a second rear bracket orifice 110 therein. It is also contemplated that the system comprises a single rear bracket 100 defining a plurality of rear bracket orifices 110. The rear bracket is designed to stop the cargo apparatus from sliding rearwardly toward the cab of the truck and the orifice is configured to substantially stop the cargo apparatus from moving laterally in the truck bed, as well as vertically. In another exemplified aspect, the retention system also comprises a front bracket 200 attachable to the bed of the truck. The front bracket is positioned at a point where it can be attached to a front portion 32 of the cargo apparatus and comprises a front bracket orifice 210. As can be appreciated, the front bracket 200 can be a plurality of front brackets.

In another aspect, the cargo apparatus 30 comprises a first rear male protrusion 120 attached to and extending from a rear portion of the cargo apparatus. This first rear male protrusion 120 is configured to be received within the first rear bracket orifice by sliding the cargo apparatus toward the rear of the bed of the truck toward the cab. In aspects where there are pluralities of rear orifices, there can be a plurality of rear male protrusions corresponding to the orifices.

In yet another aspect, the cargo apparatus comprises a front clasp 300 attached to its front portion 32 configured to selectively engage the front bracket 200. When the front clasp is engaged with the front bracket, the cargo apparatus is retained in place by at least the engagement of the rear brackets with the rear male protrusion and the clasp with the front bracket. It is contemplated that the front and rear hardware can be reversed.

In an exemplified aspect, the rear bracket orifice 110 is a slot. It is contemplated that the rear bracket orifice can be round, square, rectangular, oval, and star.

Conventional truck beds 20 comprise a plurality of spaced longitudinal ridges 22 defining a plurality of spaced longitudinal troughs 24. In one aspect, a portion of the rear bracket engages a portion of at least one of the ridges and sits in at least a portion of at least one of the troughs whereby it is restricted from moving in a lateral direction by at least one of the plurality of ridges. In another aspect, the front bracket also resides within at least a portion of at least one of the toughs and engages at least one of the ridges. In some aspects, the brackets reside within the troughs, but do not engage a portion of any of the ridges. In this aspect, being in the trough lowers the overall profile of the bracket.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein.

What is claimed is:

1. A cargo retention system for retaining a cargo apparatus in the bed of a truck, the bed of the truck having a front and a rear, the retention system comprising:
a first rear bracket attachable to the bed of the truck, the first bracket defining a first rear bracket orifice therein;
a front bracket attachable to the bed of the truck;
a first rear male protrusion attached to and extending from a rear portion of the cargo apparatus, the first male protrusion configured to be received within the first rear bracket orifice by sliding the cargo apparatus toward the rear of the bed of the truck;
a clasp attached to a front portion of the cargo apparatus configured to selectively engage the front bracket, wherein, when the front clasp is engaged with the front bracket, the cargo apparatus is retained in place by at least the engagement of the first rear bracket with the first rear male protrusion and the clasp with the front bracket.

2. The cargo retention system of claim 1, further comprising;
a second rear bracket attachable to the bed of the truck, the second rear bracket defining a second rear bracket orifice;
a second rear male protrusion attached to and extending from a rear portion of the cargo apparatus, the second male protrusion configured to be received within the second rear bracket orifice by sliding the cargo apparatus toward the rear of the bed of the truck wherein, when the front clasp is engaged with the front bracket, the cargo apparatus is retained in place by at least the engagement of the first rear bracket with the first rear male protrusion, the second rear bracket with the second rear male protrusion, and the clasp with the front bracket.

3. The cargo retention system of claim 1, wherein the first rear bracket orifice is a slot.

4. The cargo retention system of claim 1, wherein the first rear bracket orifice is chosen from the group of round, square, rectangular, oval, and star.

6. The cargo retention system of claim 1, wherein the bed of the truck comprises a plurality of spaced longitudinal ridges defining a plurality of spaced longitudinal troughs, and wherein the first rear bracket sits in at least a portion of at least one of the troughs.

7. The cargo retention system of claim 6, wherein a portion of the first rear bracket engages a portion of at least one of the ridges, whereby it is restricted from moving in a lateral direction by at least one of the plurality of ridges.

8. The cargo retention system of claim 1, wherein the cargo apparatus is a tool box.

9. The cargo retention system of claim 1, wherein the cargo apparatus is a bicycle rack.

10. The cargo retention system of claim 1, wherein the cargo apparatus is a grill.

11. A cargo retention system for retaining a cargo apparatus in the bed of a truck, the bed of the truck having a front and a rear, the retention system comprising:
a first rear bracket attachable to the bed of the truck, the first bracket defining a first rear bracket orifice therein;
a second rear bracket attachable to the bed of the truck, the second rear bracket defining a second rear bracket orifice;
a front bracket attachable to the bed of the truck;
a first rear male protrusion attached to and extending from a rear portion of the cargo apparatus, the first male protrusion configured to be received within the first rear bracket orifice by sliding the cargo apparatus toward the rear of the bed of the truck;
a clasp attached to a front portion of the cargo apparatus configured to selectively engage the front bracket, wherein, when the front clasp is engaged with the front bracket, the cargo apparatus is retained in place by at least the engagement of the first rear bracket with the first rear male protrusion, the second rear bracket with the second rear male protrusion, and the clasp with the front bracket.

12. The cargo retention system of claim 11, wherein the first and second rear bracket orifices is a slot.

13. The cargo retention system of claim 11, wherein the first and second rear bracket orifices is chosen from the group of round, square, rectangular, oval, and star.

14. The cargo retention system of claim 11, wherein the bed of the truck comprises a plurality of spaced longitudinal ridges defining a plurality of spaced longitudinal troughs, and wherein a portion of the first and second rear brackets engage a portion of at least one of the ridges and sits in at least a portion of at least one of the troughs whereby it is restricted from moving in a lateral direction by at least one of the plurality of ridges.

15. The cargo retention system of claim 11, wherein the cargo apparatus is a tool box.

16. The cargo retention system of claim 11, wherein the cargo apparatus is a bicycle rack.

17. The cargo retention system of claim 11, wherein the cargo apparatus is a grill.
